(19) United States
(12) Patent Application Publication
(10) Pub. No.: US 2013/0202737 A1
(43) Pub. Date: Aug. 8, 2013

(54) Methods and Composition for EPS-Fortified Ingredients in Cheese

(71) Applicant: Ashraf Hassan, Brookings, SD (US)

(72) Inventor: Ashraf Hassan, Brookings, SD (US)

(73) Assignee: SOUTH DAKOTA STATE UNIVERSITY, Brookings, SD (US)

(21) Appl. No.: 13/699,256

(22) PCT Filed: May 21, 2011
(86) PCT No.: PCT/US11/37482

§ 371 Date: Mar. 21, 2013

Related U.S. Application Data
(60) Provisional application No. 61/347,333, filed on May 21, 2010.

(51) Int. Cl. A23C 19/032

(52) U.S. Cl. CPC A23C 19/0323
USPC 426/40; 426/582

(57) ABSTRACT

The present disclosure relates to methods and compositions for preparing cheese products with exopolysaccharide (EPS). In particular, an EPS-producing culture is deactivated either before or shortly after combination of the EPS-fortified ingredient with a base milk ingredient, i.e. cheese milk. In many cases, the base milk ingredient is a low or reduced fat ingredient. The base milk ingredient may have an added fat. Also contemplated are cheese products made using the disclosed methods and compositions.

### CROSS-REFERENCE TO RELATED APPLICATION

This application claims priority to U.S. Provisional Patent Application Ser. No. 61/347,333, filed May 21, 2010, which application is hereby incorporated by reference in its entirety.

### STATEMENT REGARDING FEDERALLY SPONSORED RESEARCH OR DEVELOPMENT

This invention was made with U.S. Government support from the following agency: XXX. The U.S. Government has certain rights in this invention.

### TECHNICAL FIELD

The present disclosure relates to compositions and methods for the production of full fat, reduced fat and low fat cheeses using exopolysaccaride (EPS)-fortified ingredients. More particularly, in many embodiments, although the cheese contains EPS-fortified ingredients, EPS-producing cultures have been deactivated. Additionally, the compositions may include homogenized cream.

### BACKGROUND

Cheese has long been made using fat-containing milk as a primary starting ingredient. In the last few decades, much emphasis has been put on reducing fat in people's diets, and low and no-fat cheeses and cheese foods have been developed. However, fat reduction typically causes inferior cheese texture and body, and often causes other problems, such as poorer meltability and inferior cheese flavor and taste.

Exopolysaccharides (EPS)-producing cultures are commonly used in dairy foods to increase viscosity, increase water-binding, and to provide stabilizing functions. For instance, see Awad et al., “Application of Exopolysaccharide-Producing Cultures in Reduced-Fat Cheddar Cheese: Composition and Proteolysis”, 2005 J. Dairy Sci. 88:4195-4203; Awad et al., “Application of Exopolysaccharide-Producing Cultures in Reduced-Fat Cheddar Cheese: Texture and Melting Properties”, 2005 J. Dairy Sci. 88:4204-4213; Hassan et al., “Application of Exopolysaccharide-Producing Cultures in Reduced-Fat Cheddar Cheese: Cryo-Scanning Electron Microscopy Observations”, 2005 J. Dairy Sci. 88:4214-4220; Hassan et al., “Effects of Exopolysaccharide-Producing Cultures on the Viscoelastic Properties of Reduced-Fat Cheddar Cheese”, 2005 J. Dairy Sci. 88:4221-4227; Agrawal et al., “Ultrafiltered Milk Reduces Bitterness in Reduced-Fat Cheddar Cheese Made with an Exoploysaccharide-Producing Culture”, 2007 J. Dairy Sci., 90:3110-3117; Hassan, “ADSA Foundation Scholar Award: Possibilities and Challenges of Exopolysaccharide-Producing Lactic Cultures in Dairy Foods”, 2008 J. Dairy Sci., 91:1282-1298; and Perry et al., “Manufacture of Low Fat Mozzarella Cheese Using Exopolysaccharide-Producing Starter Cultures”, 1998 J. Dairy Sci. 81(2), 563-566. See also European Patent App. No. 0 639 332 A1 to Nauth et al., entitled “Method for manufacture of reduced fat Cheddar cheese”, which discloses use of a culture system including a “ropy culture”, which is generally understood as an EPS-producing culture. All of these mentioned publications and patent application are incorporated herein by reference.

However, cheese made using EPS-producing cultures have not enjoyed widespread commercial success because of problems with flavor, especially with Cheddar cheese. This is unfortunate as the major component of most process cheeses manufactured in the United States is Cheddar cheese. The quality attributes of process cheese are greatly influenced by the composition and nature of the base cheese.

Considering these various problems in cheese containing EPS-producing cultures, better methods and recipes for these types of cheeses are needed.

### SUMMARY

In one aspect, the present disclosure is directed toward a method of making a cheese product with EPS. The method includes combining an EPS-fortified ingredient with a base milk ingredient. Generally, EPS-producing micro-organisms are deactivated prior to further processing steps such as acidifying. If an EPS-producing culture is used as the EPS-fortified ingredient, the culture is substantially deactivated either before or shortly after combination with the base milk ingredient. An example EPS-producing culture is Lactococcus lactis ssp. cremoris culture.

The disclosed methods use a base milk ingredient that is a skim or reduced fat milk or dairy product in many aspects. If the base milk ingredient is a skim or reduced fat milk or dairy product, a fat may be added to the EPS-fortified ingredient or the base milk ingredient before further processing. The fat may be homogenized cream. Commonly, the methods can be used in most cheese recipes. In one case, the disclosed methods are used to make Cheddar cheese.

Consistent with a further aspect of the disclosure, compositions and cheese products made using the disclosed methods are provided. The compositions and cheese products include numerous types of cheeses.

### DETAILED DESCRIPTION

The disclosed embodiments largely utilize a conventional cheese-making process, except they begin with a modified and novel starting EPS-fortified ingredient. As used herein, a EPS-fortified ingredient is a cheese ingredient with (a) EPS or (b) a micro-organism capable of EPS production. In many embodiments, EPS-producing microorganisms are deactivated either before or shortly after addition of the EPS-fortified ingredient to the base milk ingredient, generally otherwise known as cheese milk. In one embodiment, the EPS-fortified ingredient begins as a bulk starter culture. Additionally, in certain embodiments, a homogenized cream is added to the EPS-fortified ingredient. In many embodiments, the EPS-fortified ingredient is developed and added in bulk. A first disclosed step is to develop a bulk EPS-fortified ingredient. The currently disclosed development of a bulk EPS-ingredient contrasts the general understanding that EPS-producing culture can be added in a frozen form to a milk base and then allowed to ferment in the milk base.

To develop a bulk EPS-fortified ingredient, in many embodiments, a micro-organism is used. Depending on the embodiment, a suitable micro-organism includes bacteria, molds and/or fungi, such as yeast. Generally, the term “micro-organism” encompasses micro-organisms and means a microscopic organism which may unicellular or multi-cellular which is capable of normal growth and development. The micro-organism may be a naturally occurring micro-organism or it may be a transformed micro-organism. The micro-organism may also be a combination of suitable micro-organisms.

Optionally the micro-organism may be transformed by different techniques such as genetic techniques known to the skilled artisan. As used herein the term transformed encompasses recombinant micro-organisms. The term “recombinant micro-organism” means a micro-organism which carries a recombinant nucleotide sequence coding for an enzyme which is capable of producing EPS such that both the enzyme and the EPS can be used as components of the compositions disclosed herein.

It is to be understood that where reference is made in the present specification, including the accompanying claims to ‘a’ micro-organism, such reference is meant to include one or more micro-organisms, and mixtures thereof, unless it is specifically stated otherwise in the text. An EPS-producing culture can include a single type of micro-organism, a single strain of a particular micro-organism, or a mixture of different micro-organisms and strains.

As is understood by the skilled artisan, the selection of the particular micro-organism has a significant influence on a bulk EPS-fortified ingredient. Generally, four primary criteria are considered in selection of the desired EPS-producing micro-organism.

First, the EPS-producing micro-organism should be able to develop a ropy texture. As is understood in the art, ropiness is a term used to describe threads that can be drawn out from the surface of fermented milk by a needle or other means. An increase in ropiness corresponds to an increase in viscosity of the cheese milk. EPS-producing micro-organisms can be graded based upon the amount of ropiness they are able to produce, anywhere from no ropiness (such strains producing only capsular EPS) to a slightly inconsistent viscosity to a point where the affected base can be drawn out in yarn-like threads or similar to a gel. Methods of measuring ropiness, such as with a viscosimeter or using thread measurement, are known in the art. See F. I. Samaras et al., Food Microbiology 20 (2003) 503-509. While ropiness is generally considered to be a defect in milk because it makes processing difficult, for the EPS benefits of the disclosed embodiments, in many instances micro-organisms that are able to produce more ropiness provide more beneficial results. In many embodiments, the ropiness will result in a thread of at least about 3 mm. In other embodiments, the ropiness will result in a thread of at least about 4 mm. In still other embodiments, the ropiness will result in a thread of at least about 5 mm.

Next, in most embodiments the EPS-producing microorganisms should produce an EPS with a high water binding capacity. As used with certain embodiments, an EPS with a high water binding capacity is an EPS that increases the amount of bound water in the cheese mixture by about 0.5%, about 1%, about 1.5%, about 3%, about 5% or about 7% over the same mixture without the EPS-fortified ingredient. The skilled artisan can easily determine an appropriate level of water binding capacity using measurements such as thermogravimetrical analysis. Using a EPS-producing micro-organism with high water binding capacity in a bulk EPS-fortified ingredient has several beneficial effects such as increasing water retention and minimizing the pasty texture of reduced-fat cheeses.

Third, the EPS-producing micro-organism will produce EPS with a low shear sensitivity in many embodiments. For example, in exemplary embodiments, the viscosity of the cheese mixture containing EPS will not change more than about 5%, more than about 10%, more than about 25% or more than about 50% when the cheese mixture is subjected to sheer. Fourth, the interaction between the EPS and the proteins in the milk and cheese will be considered when selecting an EPS-producing microorganism. An EPS-induced increase in whey viscosity caused by EPS/protein interaction can be a major limitation associated with EPS-producing cultures, so in many embodiments, the EPS-producing micro-organism is selected to minimize the EPS-induced increase in whey viscosity. This consideration is important particularly since heat (which can be used to deactivate the EPS-producing micro-organisms) also additionally affects interactions between the EPS and the proteins.

In many embodiments, the micro-organism is a bacterium. Using the four primary criteria above as well as cost and availability, in many embodiments, the strain of EPS-producing bacteria is a Lactococcus lactis ssp. cremoris. However, many other EPS-producing bacteria are contemplated in different embodiments, keeping in mind the four factors that will result in a better selection. Other possible EPS-producing bacteria include Lactococcus lactis ssp. lactis, Lactococcus lactis ssp. lactis var. diacetylactis, Streptococcus thermophilus, Streptococcus salivarius ssp. thermophilus, Streptococcus lactis ssp. hollandicus, Lactobacillus delbrueckii ssp. bulgaricus, Lactobacillus lactis, Lactobacillus helveticus, Lactobacillus casei and subspecies, Lactobacillus acidophilus and Leuconostoc mesenperoidis ssp. dextranicu. This list is not limited and additional bacterial strains capable of producing food quality EPS are contemplated.

Lactococcus lactis ssp. cremoris generally produces hetero-EPS, but in certain embodiments, homo-EPS-producing strains will be used. Because the EPS-producing culture will be substantially deactivated prior to cheese formation and aging, the disclosed embodiments enable significant flexibility toward selecting homo-EPS-producing strains. Additionally, because active EPS-producing culture is not used in the coagulation phase and beyond of cheese making, rotation of EPS-producing cultures in order to prevent phage attack is not needed.

The selected bacterial culture is then applied to a base substance to obtain a bulk EPS-fortified ingredient. In many embodiments, the base substance is milk. Unless otherwise designated, “milk” as used in the base substance includes skimmed milk, semi-skimmed milk, full-fat milk, cream, milk powder that has been reconstituted or recombined, milk that has been subjected to concentration method—such as evaporation or membrane filtration—or combinations thereof. Non-dairy milks such as those derived from plants such as soy or rice or synthetically generated are additionally included in the general definition of milk.

Additionally, other base substances such as dairy byproducts of the cheese making process, are contemplated in additional embodiments. One such dairy byproduct is whey. For example, standard whey may be used as the base substance. In certain embodiments, a concentrated whey, with a concentration of about 5 times the concentration of standard whey is used as the base substance. In yet other embodiments, concentrated whey with a concentration of between about 2 times and 5 times the concentration of standard whey is used. A whey protein concentrate (WPC) is also used as the base substance in certain embodiments. WPC may be particularly beneficial in situations where concentrated whey and/or fresh whey and concentration equipment is not available. In one embodiment, the WPC base substance is a 10% aqueous solution of 32% WPC.

Generally, the selected EPS-producing culture is applied to the base substance for a sufficient duration and under conditions to produce sufficient amounts of EPS in the EPS-fortified ingredient. For example, in an embodiment using EPS-producing culture of Lactococcus lactis ssp. cremoris, the WPC is warmed at 25-30° C. for about 12 hours to result in sufficient EPS production in the bulk EPS-fortified ingredient. As is well understood by the skilled artisan, other conditions and durations will be used for other bacteria and for other base substances. The sufficient amounts and the conditions to produce sufficient amounts of EPS are not meant to be limiting and can easily be determined by the skilled artisan without undue experimentation.

A sufficient amount of EPS-fortified ingredient is then added to a base milk ingredient of the cheese, i.e. cheese milk. In many embodiments, the EPS-fortified ingredient is a bulk EPS-fortified ingredient. In most embodiments, the base milk ingredient will be either a low-fat milk or skim milk to be later standardized (such as with cream) into a low-fat milk. In one embodiment, the base milk ingredient is skim cow's milk having in excess of 7% solids non-fat. However, the base milk ingredient is not meant to be limiting and cheeses formed from milk of other mammals and with different solids non-fat concentrations are contemplated. Additionally, if desired, in certain embodiments the base milk ingredient can be concentrated to achieve efficiencies in the cheese-making process. In many embodiments, the base milk ingredient is pasteurized milk. In another embodiment, the base milk ingredient is raw or unpasteurized milk. The raw or unpasteurized milk can be whole milk, reduced fat milk, or skim milk.

The amount of EPS-fortified ingredient added relative to the base milk ingredient can be determined based upon the identities of the EPS-fortified ingredient and base milk ingredient and the desired taste, texture and processing properties preferred in the resultant cheese. In one embodiment, a bulk EPS-fortified ingredient is added at a concentration of about 4% to about 5% relative to the base milk ingredient.

Either before or shortly after its addition with the base milk ingredient, if an EPS-producing culture has been used as the EPS-fortified ingredient, the EPS-producing culture is substantially deactivated. In most embodiments, “shortly after its addition” means before the mixture has been acidified. As used herein, “substantial deactivation” means that in some embodiments at least about 95% of the EPS-producing culture can no longer produce EPS. This substantial deactivation takes place prior to further processing of the cheese, i.e. prior to acidification and coagulation. In many embodiments, the EPS-producing culture is deactivated shortly after its addition with the base milk ingredient. In most embodiments using an EPS-producing culture as the EPS-fortified ingredient, the identity of the base milk ingredient is selected based upon the method of deactivation of the EPS-producing culture.

EPS-fortified ingredient can combined with base ingredient directly in the cheese vat to minimize pumping of the combination. When the EPS-fortified ingredient is an EPS-producing culture and the base ingredient is pasteurized milk, the combination is then heated for about 3 seconds within the cheese vat to a temperature of about 65° C. to substantially kill or otherwise deactivate the bacteria of the EPS-producing culture. In embodiments, where unpasteurized milk is the base ingredient, the EPS-fortified ingredient is combined with the unpasteurized skim milk and pasteurized such as by heating at 65° C. for about 30 minutes. One benefit of using raw/unpasteurized milk is that the pasteurization process itself can be used to deactivate the EPS-producing culture, while only performing a single heating operation on the raw/unpasteurized milk.

In an additional alternative embodiment, a high-temperature-short-time (HTST) pasteurization process is applied to the combination of the EPS-fortified ingredient and the base milk ingredient, which is generally raw/unpasteurized milk. An example HTST is heating at 71.5° C. for about 15 seconds. HTST pasteurization shortens processing time to obtain the deactivated EPS-fortified milk ingredient.

When the base milk ingredient is skim milk rather than reduced fat milk, in many embodiments, the skim milk is standardized to reduced fat milk. This standardization can be done by adding cream. Generally, if a fat, such as cream, has been added to skim milk, the resulting reduced fat milk base milk ingredient is demonstrated by showing the percentage of fat in the reduced fat milk as compared to the fat content of whole milk. In many embodiments, the base milk ingredient has from about 50% to about 100% of the fat content of whole milk. For example, in one embodiment, the base milk ingredient has about 67% of the fat content of whole milk, which results in a 33% reduced fat cheese. In yet other embodiments, the base milk ingredient will have a different percentage of fat as compared to whole milk. The skilled artisan can easily determine the amount of fat to add to skim milk to obtain the desired reduced fat milk base milk ingredient. While regular cream can be used, many embodiments use a homogenized cream. See Metzger et al., “A New Approach Using Homogenization of Cream in the Manufacture of Reduced Fat Cheddar Cheese. 2. Microstructure, Fat Globule Distribution, and Free Oil”, 1995 J. Dairy Sci. 78:1883-1895, incorporated by reference. An example homogenized cream is a 35-40% fat cream homogenized at 2,500 and 500 psi and 57° C. This homogenized cream is added to the skim milk to achieve an EPS-fortified ingredient base milk ingredient with between about 1.6% fat and about 3.2% fat. In one embodiment, homogenized cream is added to the EPS-fortified ingredient base milk ingredient until the EPS-fortified ingredient base milk ingredient is about 2.1% fat.

In embodiments using an EPS-fortified ingredient in the form of a bulk EPS-producing culture, deactivation of the EPS-producing culture can occur either before or shortly after the fat is added. Additionally, the EPS-fortified ingredient base milk ingredient can be ultra-filtered at a low rate (1.2×). See Agrawal et al., “Characteristics of reduced fat Cheddar cheese made from ultrafiltered milk with an exopolysaccharide-producing culture”, 2008 J. Dairy Research, 75:182-188; and Agrawal et al., “Improving texture and flavor of reduced fat Cheddar cheese using an exopolysaccharide-producing culture and ultrafiltration”. J Dairy Sci. 89(Suppl 1):108; both incorporated by reference.

Once the EPS-producing culture in the EPS-fortified ingredient base milk ingredient has been deactivated, the EPS-fortified ingredient base milk ingredient can be used as the basic milk ingredient in any cheese making recipe. This is also true for any EPS-fortified ingredient base milk ingredient without an active EPS-producing culture.

In many embodiments, the EPS-fortified ingredient base milk ingredient (with no active EPS-producing culture) is used in making Cheddar cheese. If desired, calcium chloride also may be added to the EPS-fortified ingredient base milk ingredient in the cheese recipe to generate firmer curds. Additional fortifying ingredients or colorings may also be added to the EPS-fortified ingredient base milk ingredient in many embodiments.

In exemplary embodiments, the EPS-fortified ingredient base milk ingredient is acidified when used in cheese recipes. If desired, the acidification can be achieved by adding an acidic ingredient, such as citric acid or tartaric acid, or through natural bacterial acidification. In many embodiments, acidification is achieved by adding a starter culture, such as a mesophilic, thermophilic (streptococcus thermophilus) or helvetic (lactobacillus helveticus) bacteria culture to the EPS-fortified ingredient base milk ingredient. Exemplary embodiments (for Cheddar cheese) use a mesophilic starter culture, such as a commercial Cheddar starter culture (DVS 850, Chr. Hansen Lab; 0.013% wt/wt). Other acidification starter cultures include Lactococcus lactis ssp diacetylactis and Leuconostoc cremoris. If a starter culture is used, the mixture of the acidification starter culture and the EPS-fortified ingredient base milk ingredient is then incubated. Incubation times include between about 10 minutes and about 60 minutes. In one embodiment, the acidification starter culture and the EPS-fortified ingredient base milk ingredient are incubated from about 40 minutes to about 60 minutes at a temperature between about 30° C. and about 37° C. In certain embodiments, the incubation temperature is about 31° C.

Following acidification, in many embodiments a coagulating agent such as rennet containing rennin or chymosin (Chymax, Chr. Hansen Lab) at about 0.02% to about 0.1%, is added to the EPS-fortified ingredient base milk ingredient/acidification starter culture. The rennet may be animal, microbial or vegetable. Embodiments with added coagulating agents can be used to make, in addition to Cheddar, Swiss and Colby cheese. Following addition of a coagulating agent, the mixture incubated between about 10 minutes and about 60 minutes. In many cases the mixture is incubated about 30 minutes, at a temperature between about 30° C. and about 37° C. In one embodiment, the mixture is incubated at about 31° C.

While described primarily in association with hard cheeses, the disclosed embodiments can also be used in soft cheeses such as cottage, cream cheese, mozzarella, Karish, feta, Quartirolo and similar soft cheeses.

In making Cheddar cheese, following coagulation, the mixture (which at this point has formed a mass) is cut, healed, stirred, and heated. The healing period is generally about 20 minutes in many embodiments. Exemplary embodiments include heating from about 30° C. to about 42° C. for between about 10 and about 90 minutes. In one example, the mass is warmed to about 39° C. over 30 minutes, and then held at about 39° C. for about another 30 minutes. Then the whey is drained off and the curd is matted into a cohesive mass in the traditional Cheddaring process or is intermittently stirred (the stirred curd process). Subsequently, in the traditional Cheddar process, the curd is milled when the pH reaches about 5.4 and salted, whereas in the stirred curd process, the curd is simply salted. In most embodiments, about 1% to about 4% salt, and more specifically in certain embodiments about 1.5% to about 3% salt by weight is added to the curd. In many embodiments, the salt is sodium chloride. For a Cheddar cheese, in one embodiment the salt is added to about 2.2% by weight in three equal applications over 15 minutes. The salted curd is stirred, further drained and pressed into forms. In exemplary embodiments, the pressing process is at about 20 psi for the first about 30 minutes, and then at about 80 psi for about 16 hours.

When consumed as a natural cheese, Cheddar cheese made using the disclosed embodiments is then aged for a time period in excess of one week. In certain embodiments, the Cheddar cheese is aged from about one month to about one year in a ripening room kept at about 4° C. In one embodiment, the Cheddar cheese is aged for four months prior to consumption.

If the Cheddar cheese is to be used in a process cheese, young cheese (aged less than 1 month) is used in most embodiments. See Awad et al., “Impact of exopolysaccharide-containing base cheese on characteristics of reduced fat process cheese” 2006 J. Dairy Sci. 89(Suppl 1):314; and Awad “Substituting aged cheese with exopolysaccharide-containing base cheese in making process cheese” 2006 J. Dairy Sci. 89(Suppl 1):314, both incorporated by reference.

In certain embodiments, additional ingredients are added to obtain a particular cheese. These ingredients include, but are not limited to, nonfat dry milk, a milk protein, an acidity regulator, an acid, an anticaking agent, an antifoaming agent, a coloring agent, an emulsifier, an enzyme preparation, a flavoring agent, a firming agent, a food protein, a gelling agent, a preservative, sequestrants, a stabilizer, a starch, a thickener, an oil, a fat, a cheese powder, a salt, a nutritional supplement, an acid, an enzyme, a neutraceutical, a carbohydrate, a vitamin, and a mineral. Examples may further include procream, whey cream, a dairy solid, and foodstuffs of vegetable, fruit and/or animal source. The foodstuffs may include fruit, vegetables, nuts, meat, and spices, among other foodstuffs.

### Example

The invention may be further clarified by reference to the following Example, which serves to exemplify some of the embodiments and not to limit the invention in any way. The experiments were performed using the methodology described below.

A Cheddar cheese (CC) was prepared with an EPS-producing culture of Lactococcus lactis ssp. cremoris. The base substance for the EPS-producing culture was milk and the EPS-producing culture was incubated in the base substance for 12 hours at 25°-30° C. for EPS production. This bulk EPS-producing culture was added to a base milk ingredient of unpasteurized skim milk standardized to 1.6% fat using homogenized cream. The amount of bulk EPS-producing culture added was 4%-5% of the base milk ingredient. The EPS-producing culture was deactivated using HTST pasteurization.

CC was compared against a full fat cheese (FF) and a 50% reduced fat cheese (RF). CC had an increased moisture level (about 8% higher than FF and 3% higher than RF), so a modified cooking process was used to prepare a 50% reduced fat, high-moisture cheese (RFHM) as a third comparative. Testing was performed on the four samples, with the results shown in Table I below. In Table I, all values with at least two replicates are given as means±standard error, and meltability, hardness and nitrogen testing was performed after 1 month of aging.

TABLE I

| | FF | RF | RFHM | CC |
|---|---|---|---|---|
| Moisture (%) | 38.96 ± 0.48 | 43.50 ± 0.39 | 46.10 ± 0.39 | 46.68 ± 0.48 |
| Fat (%) | 31.36 ± 0.17 | 17.39 ± 0.14 | 16.32 ± 0.14 | 15.79 ± 0.17 |
| Moisture in | 56.76 | 52.66 | 55.10 | 55.43 |
| Non-Fat | | | | |
| Substance (%) | | | | |
| Protein (%) | 25.69 ± 0.43 | 34.39 ± 0.35 | 33.29 ± 0.35 | 31.19 ± 0.43 |
| Salt (%) | 1.41 ± 0.03 | 1.39 ± 0.02 | 1.36 ± 0.02 | 1.40 ± 0.03 |
| pH | 4.98 ± 0.02 | 5.06 ± 0.02 | 5.04 ± 0.02 | 5.02 ± 0.02 |
| Meltability, cm² | 23.4 | 13.9 | 16.1 | 22.1 |
| Water-soluble | 12.47 | 9.32 | 9.92 | 13.02 |
| nitrogen, | | | | |
| % total nitrogen | | | | |
| Trichloroacetic | 8.02 | 6.80 | 6.98 | 9.34 |
| acid-soluble | | | | |
| nitrogen, % total | | | | |
| nitrogen | | | | |
| Hardness, N | 26 | 43 | 34 | 55 |
| Viscosity of | 1.78 | 1.68 | 1.76 | 1.79 |
| whey, cp | | | | |

CC resulted in a moisture level (55.43%), which was very close to that of the full fat cheese (56.76%), and closer to full fat cheese than the other reduced fat comparatives.

CC had significantly better meltability (22.1 cm²) than the other reduced fat cheeses, attaining a meltability almost equal to the meltability (23.4 cm²) of the full fat cheese. CC and FF had more uniform melting and more gradual loss of cheese shape as compared to RF and RFHM. CC also exhibited increased viscosity of the molten cheese, which generally predicts the amount of cheese used in process cheese formulations.

The water-soluble nitrogen level and the trichloroacetic acid-soluble nitrogen level of CC also demonstrated more similarity to the full fat cheese than did the other reduced fat cheeses. CC was also firmer than the other cheeses and smoother than the other reduced fat cheeses. If a reduction in rigidity of cheese made using the disclosed embodiments is desired, modified cooking to increase moisture content will likely produce a softer version.

CC did not have a substantial increase in whey viscosity. This result suggests that cheese made using the disclosed embodiments can be conveniently employed in modern cheese making facilities without having to make accommodations for the high whey viscosity of cheeses produced by other EPS-fortified ingredient methods.

CC appeared to develop an adequate peptidolytic system to further hydrolyze the bitter peptides to amino acids. Thus, any desirable starter culture could be used with the disclosed embodiments to develop the flavor desired of the resultant reduced fat cheese.

Any aspect or design described herein as “exemplary” is not necessarily to be construed as preferred or advantageous over other aspects or designs. Exemplary embodiments may be implemented as a method or composition. The word “exemplary” is used herein to mean serving as an example, instance, or illustration.

All of the references cited herein are incorporated by reference in their entireties.

From the above discussion, one skilled in the art can ascertain the essential characteristics of the invention, and without departing from the spirit and scope thereof, can make various changes and modifications of the embodiments to adapt to various uses and conditions. Thus, various modifications of the embodiments, in addition to those shown and described herein, will be apparent to those skilled in the art from the foregoing description. Such modifications are also intended to fall within the scope of the appended claims.

What is claimed is:

1.-22. (canceled)

23. A method of making cheese comprising:
providing an EPS-fortified ingredient;
combining the EPS-fortified ingredient with a base milk ingredient; and
substantially deactivating any EPS-producing microorganism in the EPS-fortified ingredient prior to further processing.

24. The method of claim 23, further comprising adding a fat prior to further processing.

25. The method of claim 24, wherein the added fat is cream.

26. The method of claim 25, wherein the cream is homogenized cream.

27. The method of claim 23, wherein further processing comprises:
acidifying the EPS-fortified ingredient base milk ingredient combination; and
coagulating the EPS-fortified ingredient base milk ingredient combination.

28. The method of claim 23, wherein the EPS-producing microorganism is bacteria.

29. The method of claim 28, wherein the EPS-producing bacteria is a Lactococcus lactis ssp. cremoris culture.

30. The method of claim 23, wherein the EPS-fortified ingredient additionally comprises a base ingredient.

31. The method of claim 30, wherein the base ingredient is milk.

32. The method of claim 30, wherein the base ingredient is whey.

33. The method of claim 23, wherein the EPS-producing micro-organism are substantially deactivated by high temperature short time pasteurization.

34. The method of claim 23, wherein the EPS-producing micro-organism are substantially deactivated by heating to about 65° C. for about 3 seconds.

35. The method of claim 23, wherein the base milk ingredient is unpasteurized milk.

36. The method of claim 23, wherein the base milk ingredient is reduced-fat milk.

37. The method of claim 36, wherein the reduced-fat milk has from about 50% to about 99.5% of the fat content of whole milk.

38. The method of claim 36, wherein the reduced fat milk is skim milk with added fat.

39. The method of claim 23, wherein the EPS-fortified ingredient comprises primarily homo-EPS.

40. The method of claim 23, wherein the EPS-fortified ingredient comprises primarily hetero-EPS.

41. A composition suitable for forming cheese, comprising (a) an EPS-fortified ingredient, wherein any EPS-producing micro-organisms in the EPS-fortified ingredient have been deactivated prior to further processing, and (b) a base milk ingredient combined with the EPS-fortified ingredient.

42. A cheese product prepared using the composition of claim 41.
